(19) United States
(12) Patent Application Publication
(10) Pub. No.: US 2009/0021630 A1
(43) Pub. Date: Jan. 22, 2009

(54) SOLID STATE IMAGING ELEMENT AND DRIVING METHOD THEREOF

(75) Inventor: Jun Hasegawa, Kurokawa-gun (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/176,081

(22) Filed: Jul. 18, 2008

(30) Foreign Application Priority Data
Jul. 20, 2007 (JP) 2007-189646

(51) Int. Cl. H04N 5/335; H04N 3/15

(52) U.S. Cl. 348/311; 348/298; 348/E05.091

(57) ABSTRACT

A solid state imaging element comprises: a plurality of photoelectric conversion elements arranged in a two-dimensional array-shape; a plurality of first electric charge transmission sections that transmit signal electric charges detected by the photoelectric conversion elements; a plurality of second electric charge transmission sections having the same transmission stage numbers, wherein said plurality of second electric charge transmission sections corresponds to said plurality of first electric charge transmission sections respectively and comprises plural subgroups each including adjacent second electric charge transmission sections in given numbers; electric charge detection sections that detects the signal electric charge transmitted from said plurality of second electric charge transmission sections, each of the electric charge detection sections being provided for each of the plural subgroups; and a transmission control section that controls, for each of the plural subgroups, an order of transmission of the signal electric charges detected by the electric

### BACKGROUND OF THE INVENTION

1. Field of the Invention

The present invention relates to a solid state imaging element having an electric charge transmission passage and also relates to a driving method thereof.

2. Description of the Related Art

Recently, the digital still camera has been reduced in size and further the resolution of the digital still camera has been enhanced. There is a tendency that the number of pixels mounted on the solid state imaging element is increased even in the case of the same optical size. However, when the number of pixels is increased, the number of signals to be read out from the solid state imaging element is also increased. Therefore, it takes time to read out the image signals, which have been photographed, from the solid state imaging element. For the above reasons, it is necessary to enhance a signal reading speed.

On the other hand, users have a strong demand for a high speed burst shot in which a plurality of photographic object images are continuously photographed at high speed. In order to meet the demand of the users, it becomes necessary to increase the signal reading speed by which signals are read out from the solid state imaging element.

As described in WO 2003/107661, the signal reading speed of the CCD type solid state imaging element having an electric charge transmission passage depends upon an operation speed of the horizontal electric charge transmission passage (HCCD, which will be referred to as horizontal CCD hereinafter) . Therefore, in order to satisfy the demand for increasing the reading speed, it is necessary to increase the transmission speed of the horizontal CCD. That is, it is necessary that the clock frequency of the transmission pulse of the horizontal CCD is increased

However, when the frequency of the transmission pulse, by which the signal electric charge is transmitted to the output section, is increased too high, the following problems may be encountered. The transmission efficiency of the horizontal CCD is lowered and the image quality is deteriorated. Alternatively, electric power consumption of driving the horizontal CCD is increased.

Therefore, when the CCD type solid state imaging element is developed from now on, it is important that the clock frequency of the horizontal CCD is suppressed and further the number of pixels is increased and furthermore the reading speed is enhanced.

One related-art method of reducing the clock frequency of the horizontal CCD is described as the first method in JP-A-2001-119010 and Japanese Patent No. 2785782. Another related-art method of reducing the clock frequency of the horizontal CCD is described as the second method in WO 2003/107661 and JP-A-6-97414.

In the first method, a plurality of horizontal CCD are used. In this first method, operation is executed in such a manner that a sensor section of the solid state imaging element is divided into a plurality of blocks and signals are transmitted and outputted by the horizontal CCD respectively provided corresponding to the blocks,

In the second method, the horizontal CCD is not used. In this second method, operation is executed in such a manner that for each vertical electric charge transmission passage (VCCD which will be referred to as vertical CCD hereinafter) or for each vertical CCD group in which several vertical electric charge transmission passages are gathered, an electric charge detecting section such as a floating diffusion amplifier (FDA) is provided and the signal electric charge is converted to a voltage signal by this electric charge detecting section.

Concerning the solid state imaging element in which a plurality of horizontal CCD are used, it is necessary to devise a structure in which the plurality of horizontal CCD are accommodated at a limited pitch when the solid state imaging element is manufactured on a semiconductor base board. According to the related art described in JP-A-2001-119010, the vertical CCD are closely arranged in the intermediate register region and in order to prevent an increase in the area when the horizontal CCD are arranged, the tapered CCCD are used.

However, the following problems may be encountered in this related art. When the pixel pitch is reduced in order to increase the number of pixels, it becomes difficult to arrange a plurality of horizontal CCD, Therefore, the number of the vertical CCD, which are charged by the individual horizontal CCD, is increased. Accordingly, an influence, which is caused when the sensitivities of the floating diffusion amplifiers corresponding to the respective horizontal CCD are different from each other, becomes remarkable and longitudinal stripes remarkably appear on the photographed image.

According to the related art described in Japanese Patent No. 2785782, the number of stops of the vertical CCD is changed step-wise and a plurality of horizontal CCD are arranged there step-wise. In this related art, the following problems may be encountered. A driving method of driving the vertical CCD becomes complicated and a circuit size of the timing generator for driving the electric charge transmission passage is increased

In both cases of JP-A-2001-119010 and Japanese Patent No. 2785782, the horizontal CCD must be provided. Accordingly, the number of manufacturing processes is increased and the manufacturing cost is raised.

On the other hand, in the case of employing a method in which the horizontal CCD are not used, as shown in JP-A-6-97414, it is preferable that one floating diffusion amplifier (FDA) is arranged for one vertical CCD. However, when each component is actually made to be fine, it becomes necessary that the floating diffusion amplifier is formed, for example, at the width of 2 μm, the realization of which is very difficult. Therefore, as described in WO 2003/107661, it is actual that a plurality of adjoining vertical CCD are gathered and classified to groups and one electric charge detector is provided in each group.

As an example in which outputs of a plurality of vertical CCD are received by one electric charge detector, WO 2003/107661 describes a method in which an output gate (OG) provided between each vertical CCD and floating diffusion amplifier is individually controlled for each vertical CCD and a signal electric charge for each vertical CCD is read out in order. However, in this method, it is difficult to connect the output gate to the electrode by wiring.

In the invention described in WO 2003/107661, in order to evade the above difficulty, a phase of the final electrode of the plurality of vertical CCD coming into contact with the output gates (OG) is shifted and signal electric charges are alternately read out from between the electrodes, the phases of which are different from each other By this special layout and drive, the output gate (OG) can be commonly used in the vertical CCD.

However, in this case, the following problems may be encountered. From the physical viewpoint, it is difficult to lay out the electrodes of the vertical CCD. The larger the number of the vertical CCD to be gathered, the more difficult the layout of the vertical CCD. Since the driving method becomes complicated, a structure of the timing generator for generating the driving pulses becomes complicated.

### SUMMARY OF THE INVENTION

An object of the present invention is to provide a solid state imaging element, in which one electric charge detector is provided for a plurality of vertical CCD and no horizontal CCD are provided, characterized in that: the layout can be easily designed; the manufacture can be easily executed; and the electrodes of the vertical CCD can be easily laid out. Another object of the present invention is to provide a driving method of easily driving the solid state imaging element.

The present invention provides a solid state imaging element comprising: a plurality of photoelectric conversion elements arranged in a two-dimensional array-shape; a plurality of first electric charge transmission sections that transmit signal electric charges detected by the photoelectric conversion elements; a plurality of second electric charge transmission sections having the same transmission stage numbers, wherein said plurality of second electric charge transmission sections corresponds to said plurality of first electric charge transmission sections respectively and comprises plural subgroups each including adjacent second electric charge transmission sections in given numbers, electric charge detection sections that detects the signal electric charge transmitted from said plurality of second electric charge transmission sections, each of the electric charge detection sections being provided for each of the plural subgroups; and a transmission control section that controls, for each of the plural subgroups, an order of transmission of the signal electric charges detected by the electric charge detection sections.

The transmission control section may control the order of transmission by controlling independently each of the second electric charge transmission sections in each of the plural subgroups.

The transmission control section may control, for each of the plural subgroups, the order of transmission by controlling transmission/non-transmission to a next step of a signal electric charge which has been transmitted to a given position in the second electric charge transmission sections.

The transmission control section may transmit, for each of the plural subgroups, all or a portion of the signal electric charges in time series to corresponding one of the electric charge detecting sections.

The transmission control means may transmit, for each of the plural subgroups, the signal electric charges which have been transmitted in a plurality of predetermined second electric charge transmission sections to corresponding one of the electric charge detection sections at the same time.

The present invention provides a driving method of driving a solid state imaging element, the solid state imaging element comprising: a plurality of photoelectric conversion elements arranged in a two-dimensional array-shape; a plurality of first electric charge transmission sections that transmits signal electric charges detected by the photoelectric conversion elements; a plurality of second electric charge transmission sections having the same transmission stage numbers, wherein said plurality of second electric charge transmission sections corresponds to said plurality of first electric charge transmission sections respectively and comprises plural subgroups of the adjacent second electric charge transmission sections in given numbers; and electric charge detection sections that detects the signal electric charge transmitted from said plurality of second electric charge transmission sections, each of the electric charge detection sections being provided for each of the plural subgroups of the second electric charge transmission sections, wherein the driving method comprising controlling each of the plural subgroups of the second electric charge transmission sections so as to control an order of transmission of a given number of signal electric charges in each of the plural subgroups to corresponding one of the electric charge detecting sections.

### BRIEF DESCRIPTION OF THE DRAWINGS

FIG. 1 is a schematic illustration showing a surface of the CCD type solid state imaging element of an embodiment of the present invention;

FIGS. 2A and 2B are detailed arrangement views showing a primary portion of the CCD type solid state imaging element shown in FIG. 1;

FIGS. 3A and 3B are schematic illustrations showing operation in a connecting portion in which the first vertical CCD is connected to the second vertical CCD shown in FIGS. 2A and 2B;

FIGS. 4A and 4B are schematic illustrations showing operation of transmitting signal electric charges from the second vertical CCD to FDA shown in FIGS. 2A and 2B;

FIGS. 5A and 5B are schematic illustrations for explaining transmitting operation executed in a portion in which one mode operation electrode set (Vₛ1 to Vₛ4) shown in FIGS. 2A and 2B is arranged;

FIGS. 6A and 6B are views showing circumstances in which the usual transmission is executed when two mode operation electrode set (Vₛ1′ to Vₛ4′) shown in FIGS. 2A and 2B is given transmission clocks;

FIGS. 7A and 7B are schematic illustrations showing operation in a portion in which two mode operation electrode set shown in FIGS. 2A and 2B is arranged;

FIGS. 8A and 8B are schematic illustrations showing operation, which is different from that shown in FIGS. 7A and 7B, in a portion in which two mode operation electrode set shown in FIGS. 2A and 2B is arranged;

FIGS. 9A and 9B are schematic illustrations showing operation of the time series outputting of the rearrangement of the signal electric charges executed in the second vertical CCD shown in FIGS. 2A and 2B;

FIGS. 10A and 10B are schematic illustrations showing the time series outputting of another embodiment of the present invention;

FIG. 11 is an arrangement view showing a portion corresponding to FIGS. 2A and 2B in which an example of the embodiment of the present invention for executing the pixel mixing is shown;

FIGS. 12A and 12B are schematic illustrations showing operation in the case of executing the usual time series outputting without mixing pixels in the embodiment shown in FIG. 11; and

FIGS. 13A and 13B are schematic illustrations showing operation in the case of executing the usual time series outputting when pixels are mixed with each other in the embodiment shown in FIG. 11.

### DETAILED DESCRIPTION OF THE INVENTION

Referring to the drawings, an embodiment of the present invention will be explained as follows.

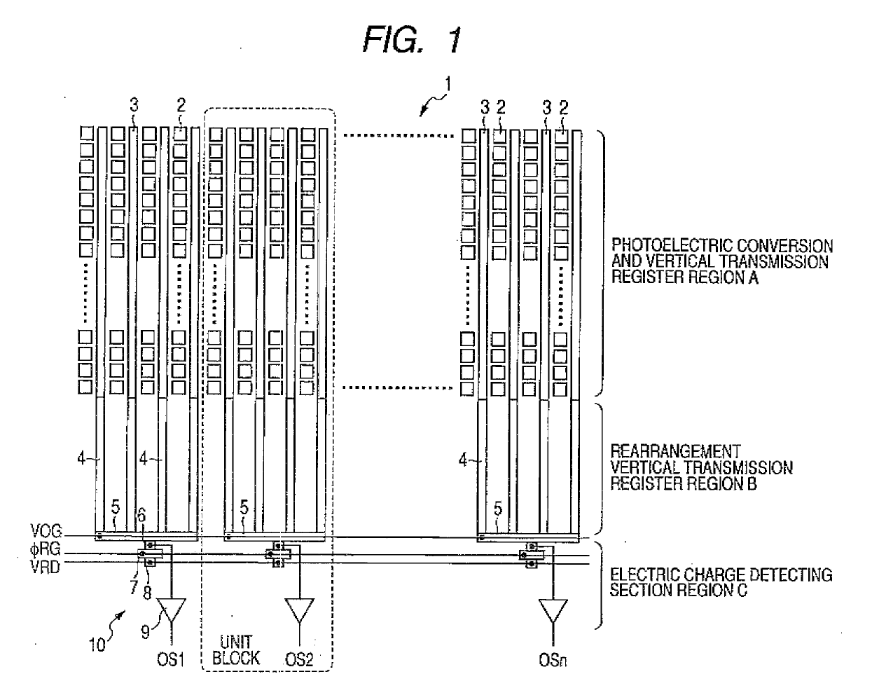

FIG. 1 is a schematic illustration showing a surface of the CCD type solid state imaging element of an embodiment of the present invention. The solid state imaging element 1 of the embodiment of the present invention is provided being divided into three regions of the regions A, B and C. In the region (the photoelectric transmission and vertical transmission register region) A, a plurality of PD (photo-diodes) 2, which are photoelectric transmission elements (photo-sensitive section), are two-dimensionally arranged. Along each row of PD, the vertical CCD 3 is arranged, The structure of this region A is the same as that of the light receiving region of the related-art CCD type solid state imaging element. Signal electric charges generated in PD 2 are read out by the vertical CCD 3. In the example shown in the drawing, these signal electric charges are transmitted downward in order by the vertical CCD 3. The vertical CCD 3 in this region A will be referred to as a first vertical CCD.

Tn the region (the vertical transmission register region rearranged) B which is arranged being adjacent to the lower side of the region A, a plurality of vertical CCD 4 respectively connected to the first vertical CCD 3 are arranged being continued to the first vertical CCD 3. The numbers of the transmission steps of the vertical CCD 4 are the same. The vertical CCD 4 in this region B will be referred to as a second vertical COD hereinafter. In the region B, a plurality of signal electric charges, which are simultaneously transmitted from the region A in parallel, are received and the order of the signal electric charges is controlled and rearranged and then outputted to the region C, the detail of which will be described later.

The region (the electric charge detecting section region) C is a region in which the electric charge detecting section provided at an end portion of the second vertical CCD 4 in the region B is provided. In the present embodiment, with respect to the second vertical CCD 4, the number of which is 4, one output gate (OG) 5 for gathering the output end portions of the second vertical CCD 4, the number of which is 4, is provided and one floating diffusion amplifier (FDA) 10 connected to the OG section 5 is also provided.

As well known, FDA 10 includes: a floating diffusion (FD) section 6; a reset gate (RG) portion 7; a reset drain (RD) section 8; and a source follower amplifier 9. Signal electric charges given to the OG section 5 in the order determined by the rearranging vertical register region B are converted to voltage value signals in this region C and then outputted in order as image signals

By the constitution described above, in the solid state imaging element of the present embodiment, a signal electric charge corresponding to a quantity of received light is detected by the photo-diode 2 and each signal electric charge is read out by the first vertical CCD 3 and transmitted. Next, the signal electric charges, which are simultaneously taken in by the second vertical CCD 4 divided into blocks (groups) of tour pieces, are controlled for each block so that the output order can be determined. Four image signals are outputted in time series from FDA 10 provided for each block. These image signals are simultaneously outputted for each block.

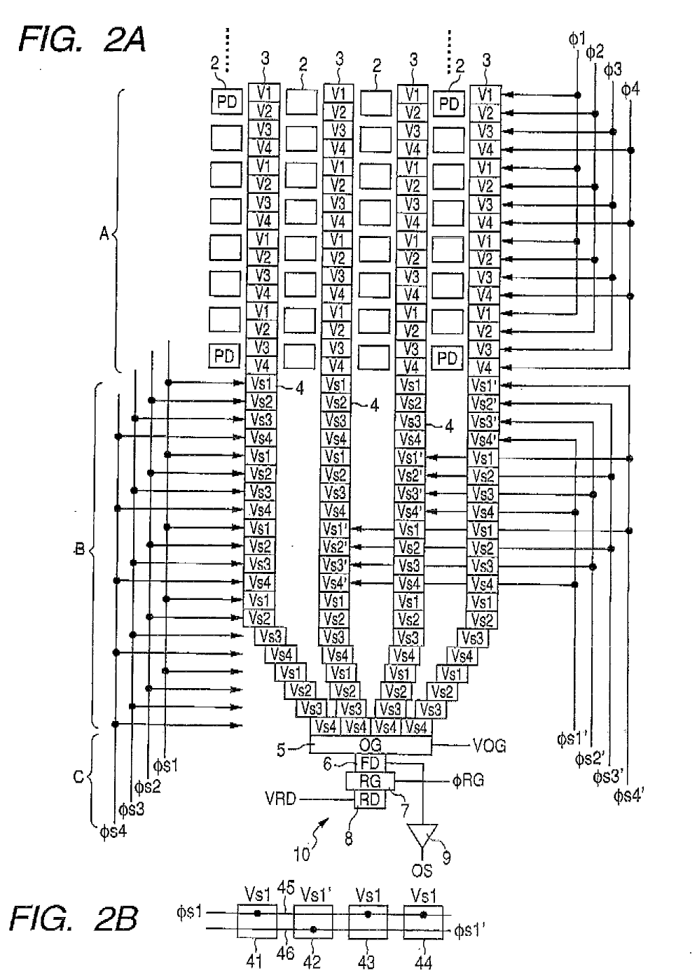

FIG. 2A is a detailed arrangement view of unit blocks in which four vertical CCD compose one unit. The first vertical CCD 3 in the photoelectric transfer and vertical transmission register region A composes a one step transmission register by four transmission electrodes of V1 to V4 and the clocks φ1 to φ4 of 4 phases are connected to each transmission electrode.

In the present embodiment, the photo-diode (PD) 2 is an interlace type CCD in which one PD 2 corresponds to two transmission electrodes of the vertical CCD 3. However, the photo-diode (PD) 2 may be a progressive type CCD in which one PD 2 corresponds to four transmission electrodes,

The first vertical CCD 3, the number of which is 4, in the region A are arranged so that the final electrode of the first vertical CCD 3 and the first electrode of the second vertical CCD 4 can be adjacent to each other so that the first vertical CCD 3 can be respectively connected to the second vertical CCD 4, the number of which is 4, in the rearranged vertical transmission register region B. Further, an embedding channel on the semiconductor base board, to which the signal electric charges are transmitted, is continuously formed from the first vertical CCD 3 to the second vertical CCD 4.

The second vertical CCD 4 in the region B includes: a portion in which four transmission electrodes of Vₛ1 to Vₛ4, to which the transmission clocks φₛ1 to φₛ4 are connected, are made to be one set; and a portion in which four transmission electrodes of Vₛ1′ to Vₛ4′, to which the transmission clocks φₛ1′ to φₛ4′ are connected, are made to be one set.

In this case, the transmission electrodes of Vₛ1 to vₛ4 are a set of transmission electrodes, which will be referred to as a set of one mode operation electrodes hereinafter, of a single mode operation which executes only a single transmission operation of 4 phases. The transmission electrodes of Vₛ1′ to Vₛ4′ are a set of transmission electrodes, which will be referred to as a set of two mode operation electrodes hereinafter, which executes operation when one of the two operation modes of transmission and non-transmission is selected. A mode of the two mode operation electrode set is changed over when the clocks φₛ1 to φₛ4 impressed upon the transmission electrodes Vₛ1′ to Vₛ4′ are made to be “the transmission clocks” by which the transmission operation is executed. Alternatively, a mode of the two mode operation electrode set is changed over when the clocks φₛ1 to φₛ4 impressed upon the transmission electrodes Vₛ1′ to Vₛ4′ are made to be “the no-transmission clocks” by which the transmission operation is not executed. These clocks are generated when a timing generator, which is a transmission control means not shown in the drawing, is given an indication from CPU mounted on a digital camera and so forth.

FIG. 2B is an impression wiring diagram of impressing transmission pulses upon the second vertical CCD 4. Four transmission electrodes for impressing the transmission pulse φₛ1 of the second vertical CCD 4 shown in FIG. 2A are laterally arranged as shown in FIG. 2B. For example, these four transmission electrodes 41, 42, 43, 44 axe formed out of a polysilicon film. On the polysilicon film, pulse impression wires, which are formed out of the metallic wires 45, 46, are provided.

The metallic wire 45 for impressing the usual transmission pulse φₛ1 is contacted with three transmission electrodes 41, 43, 44 which are the transmission electrodes Vₛ1 in the four transmission electrodes 41 to 44. The metallic wire 46 for impressing the clock φₛ1′ is contacted only with the transmission electrode Vₛ1′ (the transmission electrode 42 in the embodiment shown in the drawing) .

As show in FIG. 2A, the rearrangement vertical transmission register region B is manufactured so that the shape can be finally gradually reduced. That is, the rearrangement vertical transmission register region B is arranged so that intervals of the second vertical CCD 4 can be reduced. The rearrangement vertical transmission register region B is manufactured so that all the final electrodes of the second vertical CCD 4, the number of which is 4, come close to each other and contact the OG section 5. The FD section 6 of FDA 10 is formed being adjacent to this OG section 5. The RG section 7 is formed being adjacent to the FD section 6. The RG section 8 is formed being adjacent to the RG section 7. The source follow amplifier 9 is connected to the FD section 6.

The FDA 10 can receive all the outputs of the second vertical CCD 4, the number of which is 4. When signal electrodes axe sent from only the second vertical CCD 4, the number of which is single, a voltage value signal output corresponding to the signal electric charge of the second vertical CCD 4 is obtained. In the case where signal electric charges are simultaneously sent from a plurality of second vertical CCD 4, the signal electric charges of the second vertical CCD 4 are added to each other and a signal output corresponding to the sum is obtained.

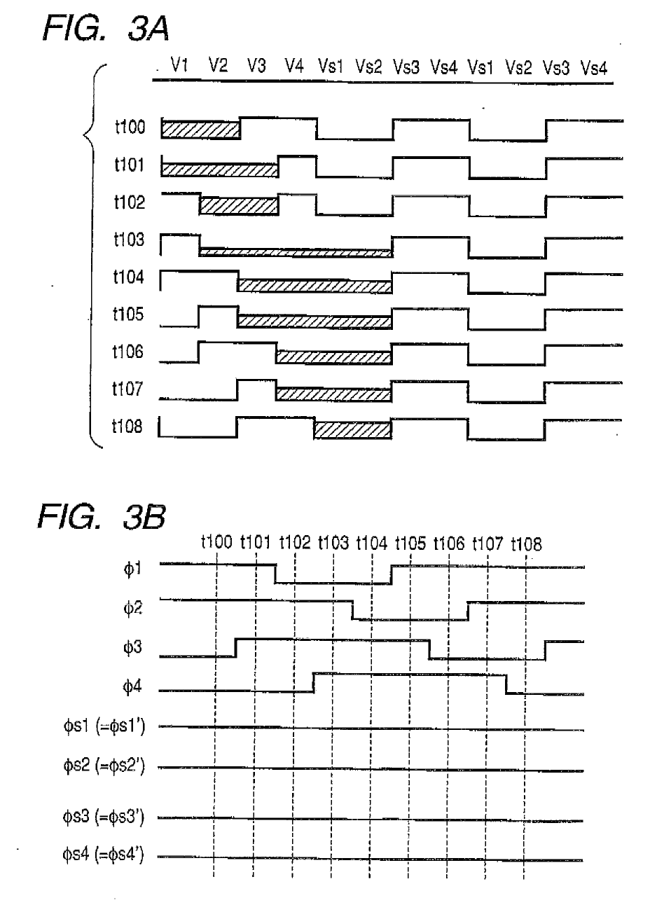

Referring to FIGS. 3A and 3B, operation of each section shown in FIG. 2A will be explained in detail. FIG. 3A is a schematic illustration showing operation in a connecting portion in which the first vertical CCD 3 is connected to the second vertical CCD 4. FIG. 3A is a potential transition diagram. FIG. 3B is a timing chart of the transmission clock (the transmission pulse) φₛ1 (=φₛ1′) to φₛ4 (=φₛ4′).

V1 to V4 shown in the drawing are transmission electrodes of the first vertical CCD 3. Vₛ1 to Vₛ4 are transmission electrodes of the second vertical CCD 4. The clocks φₛ1 to φₛ4 impressed upon the electrodes Vₛ1 to Vₛ4 of the second vertical CCD 4 are not changed during the period of time t100 to t108. Level H is impressed upon the electrodes Vₛ1 and Vₛ2. Level L is impressed upon the electrodes Vₛ3 and Vₛ4.

Due to the foregoing, deep potential wells are formed below the electrodes Vₛ1 and Vₛ2 of the second vertical CCD 4 and potential wells formed below the electrodes Vₛ3 and Vₛ4 are shallow. This state is maintained during the period of time from t100 to t108.

On the other hand, states of the clocks φ1 toφ4 impressed upon the electrodes V1 to V4 of the first vertical CCD 3 are changed momentarily At the time t100, the states of the clocks φ1 to φ4 impressed upon the electrodes V1 to V4 are respectively “H, H, L, L”. Below the electrodes V1, V2, deep potential wells are formed. Potential wells formed below the electrodes V3, V4 are shallow. Due to the foregoing, signal electric charges transmitted by the first vertical COD 3 are accumulated in the potential wells formed below the electrodes V1, V2.

At the time t101, the electric potential of the electrode V3 is changed from L to H and the potential well below the electrode V3 becomes deep. Signal electric charges distributed below the electrodes V2, V3 are also distributed below the electrode V3. Further, at the time t102, the electric potential of the electrode V1 is changed from H to L and the potential well below the electrode V1 becomes shallow. Accordingly, signal electric charges accumulated below the electrode V1 are transmitted below the electrodes V2, V3.

Successively, when level H is impressed upon the electrode V4 at the time t103, a deep potential well is formed below the electrode V4. Therefore, a large region from below the electrode V2 of the first CCD 3 to below the electrode Vₛ2 of the second vertical CCD 4 becomes a deep potential well. Signal electric charges are accumulated in this large potential well.

After that, when the voltage impressed upon the electrode V2 is changed from H to L at the time t104, the potential well below the electrode 2 becomes shallow and signal electric charges distributed below the electrode V2 are moved to below the electrodes V3, V4, Vₛ1, Vₛ2. When the same thing is repeated, signal electric charges are finally accumulated only below the electrodes Vₛ1, Vₛ2 of the second vertical CCD 4 at the time t108. In this way, the transmission of electric charges from the first vertical CCD 3 to the second vertical CCD 4 is completed.

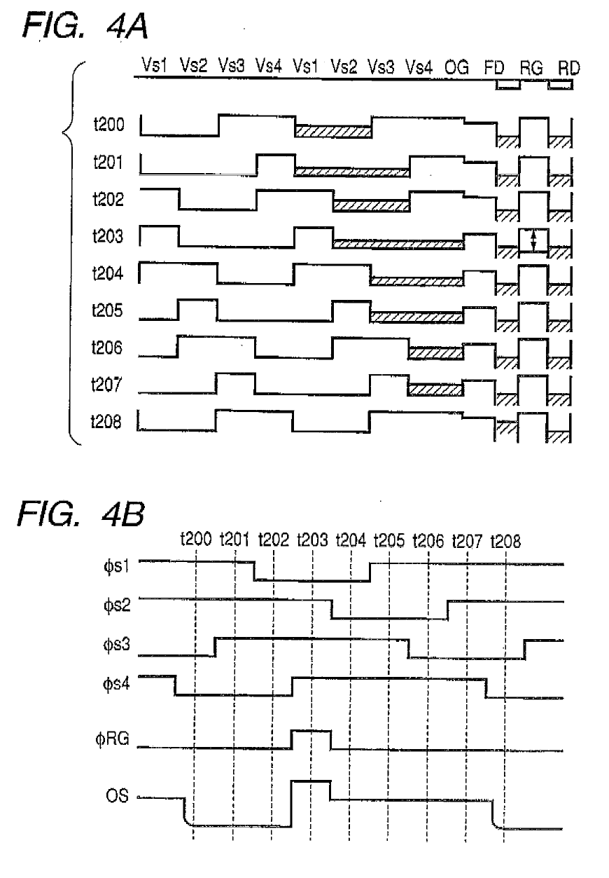

FIGS. 4A and 4B are schematic illustrations showing operation of transmitting signal electric charges from the second vertical CCD 4 to FDA 10. FIG. 4A is a potential transition diagram and FIG. 4B is a timing charge of the transmission clocks φₛ1 to φₛ4.

Vₛ1 to Vₛ4 are transmission electrodes of the second vertical CCD 4. OG is an output gate, FD is a floating diffusion region, RG is a reset gate and RD is a reset drain.

The electrodes Vₛ1 to Vₛ4 are impressed with the transmission clocks φₛ1 to φₛ4. DC voltage VOG, which is set to be an electric potential lower than the electric potential formed below the electrode Vₛ4 impressed with level L, is impressed upon OG.

RD is a reset drain and given a DC voltage sufficiently deeper than the electric potential below the OG electrode. RG is a rest gate and its electric potential is deeper than the electric potential of RD at the time of impression of level H. At the time of impression of level L, RD is impressed with the clock φRG at which the electric potential can be sufficiently higher than the RD electric potential.

At the time t200, states of the clocks φₛ1 to φₛ4 impressed upon the electrodes Vₛ1 to Vₛ4 are respectively “H, H, L, L”. Below the electrodes Vₛ1 , vₛ2, deep potential wells are formed and potential wells formed below the electrodes Vₛ3 , Vₛ4 are shallow.

In the case where signal electric charges are accumulated below the electrodes Vₛ1, Vₛ2 of the electrode set adjoining OG, when the time lapses away from t201 to t207, these signal electric charges are finally accumulated only below the electrode Vₛ4 adjoining the OG electrode. When the level of the electrode vₛ4 is changed from H to L at the next time t208, the accumulated signal electric charges exceed OG and are transmitted to the FD section. Therefore, the electric potential of the FD section is lowered by a quantity corresponding to the quantity of the signal electric charges. This is an output signal (OS) and observed by the amplifier 9.

Of course, at an appropriate timing before the level of the electrode Vₛ4 is changed from H to L, the pulse φRG is inputted and the voltage level of FD is reset.

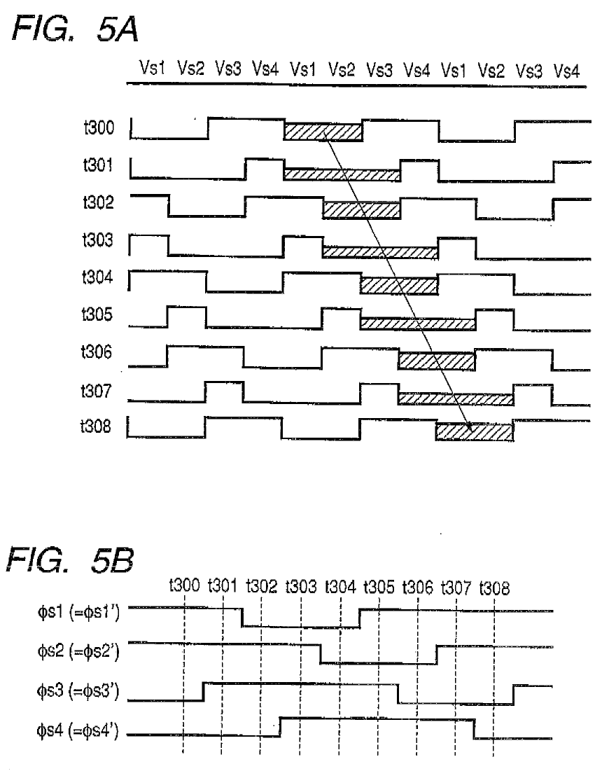

Next, referring to FIGS. 5A to 5B, operation of transmission/non-transmission of the signal electric charges in the second vertical CCD 4 will be explained below FIG. 5A is a schematic illustration for explaining transmitting operation executed in a portion in which “one mode operation electrode set (Vₛ1 to Vₛ4)” is arranged. FIG. 5A is a potential transition diagram and FIG. 5B is a timing chart of the transmission clock φₛ1 (=φₛ1′) to 4 (=φₛ4′)

At the time t300, states of the clocks φₛ1 to φₛ4 impressed upon the electrodes Vₛ1 to Vₛ4 are “H, H, L, L”. Deep potential wells are formed below the electrodes Vₛ1, Vₛ2 and potential wells formed below the electrodes Vₛ3, Vₛ4 are shallow. Accordingly, signal electric charges are accumulated below the electrodes Vₛ1, Vₛ2.

At the next time t301, the electric potential o0 the electrode Vₛ3 is changed from L to H and the potential well below the electrode Vₛ3 becomes deep. As a result, signal electric charges distributed below the electrodes Vₛ1, Vₛ2 are also distributed below the electrode Vₛ3. Further, when the tirne lapses to the time t302, the electric potential of the electrode Vₛ1 is changed from H to L and the potential well below the electrode Vₛ1 becomes shallow. Accordingly, signal electric charges accumulated below the electrode Vₛ1 are transmitted below the electrodes Vₛ2, Vₛ3. When the transmitting operation described above is repeated until time t303 to time t308, the signal electric changes existing below the electrodes Vₛ1, Vₛ2 shown in the neighborhood of the center of FIG. 5A at first are transmitted below the electrodes Vₛ1, Vₛ2 of the adjoining electrode set by an amount of one step.

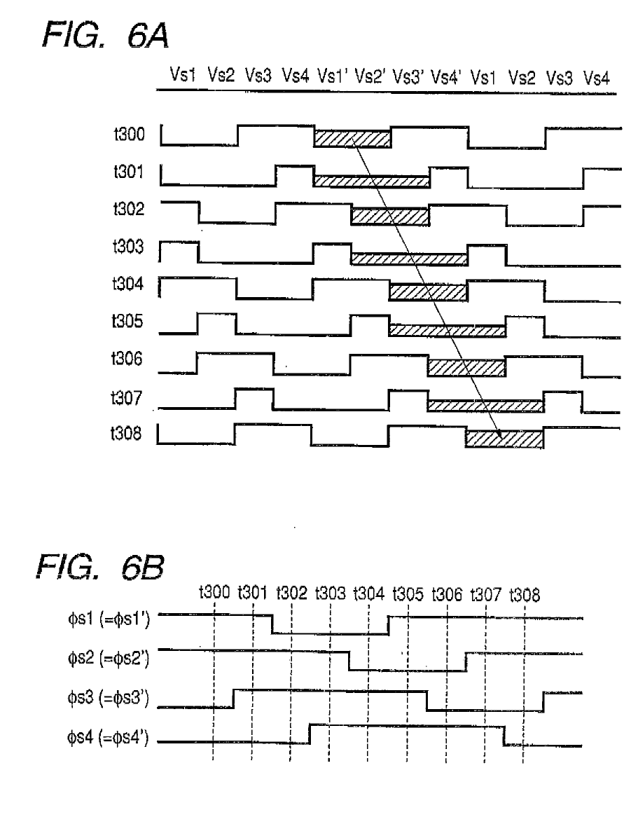

FIGS. 6A, 6B, 7A, 7B, 8A and 8B are schematic illustrations showing operation executed in “two mode operation electrode sot (Vₛ1′ to Vₛ4′)” which is executed in operation of “one mode operation electrode set (Vₛ1 to Vₛ4)” which i s only a simple transmitting operation explained in FIGS. 5A and 5B.

First, FIGS. 6A and 6B are explained below. FIGS. 6A and 6B are views showing circumstances in which the usual transmission is executed by the electrode set Vₛ1′ to Vₛ4′ when two mode operation electrode set Vₛ1′ to Vₛ4′ is given transmission clocks. FIG. 6A is a potential transition diagram and FIG. 6B is a timing chart of the transmission clocks.

In this case, the clocks φₛ1′ to φₛ4′ impressed upon the transmission electrodes Vₛ1′ to Vₛ4′ are completely the same as the clocks φₛ1 to Vₛ4 impressed upon the transmission electrodes Vₛ1 to Vₛ4. Therefore, the transmission electrodes Vₛ1′ to Vₛ4′ execute the same operation as that of the transmission electrodes Vₛ1 to Vₛ4. Accordingly, the potential transition diagram shown in FIG. 6A is the same as the potential transition diagram shown in FIG. 5A.

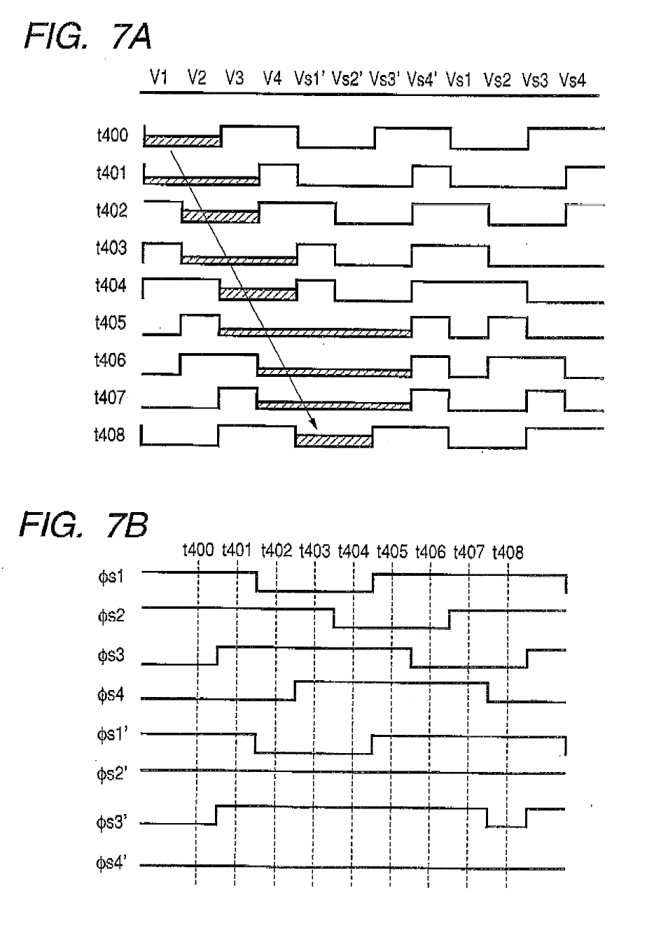

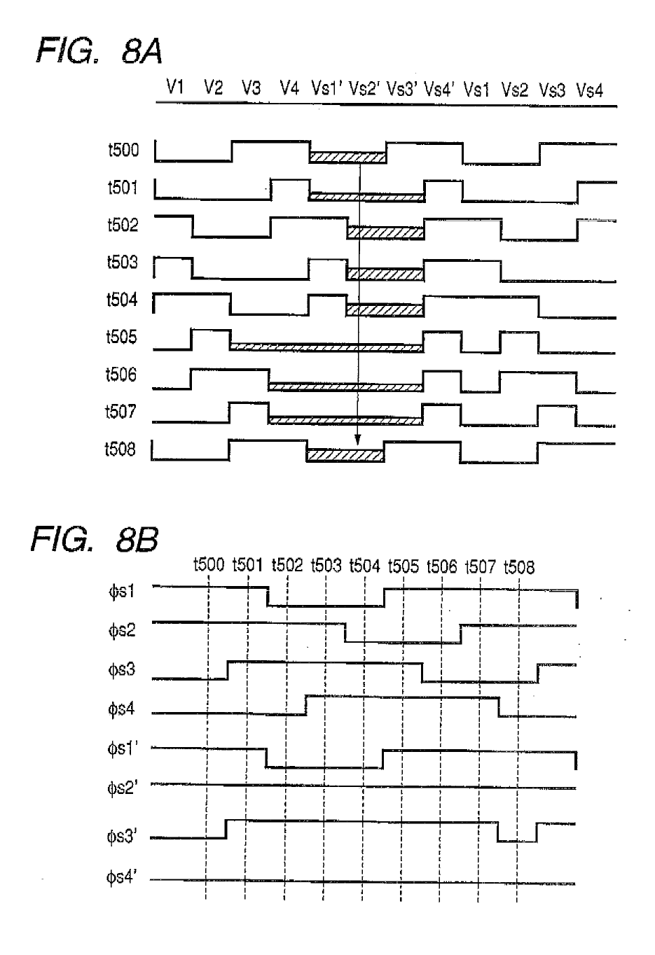

FIGS. 7A, 7B, 8A and 8B are schematic illustrations for explaining a portion in which “two mode operation electrode set” is arranged in operation of “one mode operation electrode set”. FIGS. 7A and 8A are potential transition diagrams and FIGS. 7B and 8B are timing charts of the transmission clocks.

FIGS. 7A and 7B show a case in which signal electric charges are existing below one mode transmission electrode set in the initial state. FIGS. 8A and 8B show a case in which signal electric charges are existing below two mode transmission electrode set in the initial state.

In the operation explained in FIGS. 7A, 7B, 8A and 8B, pulses of the transmission clocks φₛ1 to φₛ4 and pulses of the transmission clocks φₛ′ to φₛ4′ are different from each other. Therefore, transmission states of the electric potential wells below the transmission electrodes Vₛ1 to Vₛ4 and transmission states of the electric potential wells below the transmission electrodes Vₛ1′ to Vₛ4′ are different from each other as explained below.

In FIGS. 7A and 7B, at the time t400, states of the transmission clocks φₛ1 to φₛ4 impressed upon the transmission electrodes Vₛ1 to Vₛ4 are respectively “H, H, L, L”. Therefore, deep potential wells are formed below the transmission electrodes Vₛ1, Vₛ2 and the potential wells below the transmission electrodes Vₛ3, Vₛ4 are shallow. Therefore, signal electric charges are accumulated below the transmission electrodes Vₛ1, Vₛ2. In accordance with the lapse of the time from t401 to t404, the signal electric charges are successively transmitted and accumulated below the transmission electrodes Vₛ3, Vₛ4 adjacent to the electrode Vₛ1′.

At the time t405, level H is impressed upon the transmission electrode Vₛ1′. Therefore, the electric potential below the transmission electrode Vₛ1′ is lowered and signal electric charges are accumulated being extended in a wide range below the transmission electrodes Vₛ3, Vₛ4, Vₛ1′, Vₛ2′, Vₛ3′. After that, at the time t407, t408, signal electric charges are finally accumulated below the transmission electrodes Vₛ1′, Vₛ2′.

Due to the foregoing, the signal electric charges existing below the transmission electrodes Vₛ1, Vₛ2 at the time t400 are transmitted below the transmission electrodes Vₛ1′, Vₛ2′ at the time t408. This shows that the signal electric charges are transmitted from “one mode operation electrode set” to “2 mode operation electrode set” under the condition that transmission clocks are given to “one mode operation electrode set” and non-transmission clocks are given to “two mode operation electrode set”.

Next, referring to FIGS. 8A and 8B, explanations are made into a case in which signal electric charges are existing below the transmission electrode set of two mode operation.

At the time t500, states of the transmission clocks φₛ1′ to φₛ4′ impressed upon the transmission electrodes Vₛ1 to Vₛ4 are respectively “H, H, L, L” Therefore, deep potential wells are formed below the transmission electrodes Vₛ1′, Vₛ2′. Therefore, signal electric charges are accumulated below the transmission electrodes Vₛ1′, Vₛ2′.

At the lapse of the time t501 and time t502, the deep electric potential well formed in the second vertical CCD are respectively moved to the right in FIG. 8A and the signal electric charges are held in the electric potential walls transmitted below the transmission electrodes Vₛ2′, Vₛ3′.

Next, at the lapse of the time from t503 to t504, the electric potential wells, which are adjacent to the electric potential wells in which the signal electric charges are accumulated, are transmitted to the right in FIG. 8A, that is, in the example shown in the drawing, the deep electric potential wells, which are formed below the transmission electrodes Vₛ2, Vₛ3, are transmitted to the right in FIG. 8A.

However, as shown in FIG. 8B, in the deep electric potential wells which are formed below the transmission electrodes Vₛ2′, Vₛ3′ in which the signal electric charges are accumulated, the impression voltage to be impressed upon the transmission electrode Vₛ4′ is maintained at level L even at the time t503 and t504. Therefore, the electric potential below the transmission electrode Vₛ4′ composes a barrier and no transmission is made.

When the potential barrier, which is formed between the deep electric potential wells, in which the signal electric charges are accumulated, formed at the time t504 and the deep electric potential wells, which is farmed below the transmission electrodes Vₛ3, Vₛ4, is eliminated at the time t505, the signal electric charges are held in a large electric potential well, which corresponds to five electrodes, formed below the electrodes Vₛ3, Vₛ4, Vₛ1′, Vₛ2′, Vₛ3′.

At the next time t506 and t507, the deep electric potential well, in which the signal electric charges are accumulated, are reduced to an amount corresponding to four electrodes Vₛ4, Vₛ1′ Vₛ2′, Vₛ3′. Therefore, the electric potential well returns to the same state as that of the initial time t500.

As described above, in the present embodiment, the signal of level L is always continuously impressed upon the electrode Vₛ4′ in the period from the time t500 to the time t508. Therefore, no electric charges are transmitted beyond the electrode Vₛ4′. That is, in the operation shown in FIGS. 8A and 8B, the transmission of the signal electric charges below the electrodes Vₛ1′, Vₛ2′ is stopped.

The above explanations are summarized as follows.

(1) Concerning “the two mode operation electrode set” to which “the transmission clocks” are given, in the same manner as that of the case in which “the transmission clocks” are given to “the one mode operation electrode set”, both the transmission from the front step and the transmission to the rear step can be executed.

(2) It is possible to execute a transmission from the front step to “the two mode operation electrode set” to which “the non-transmission clocks” are given.

(3) It is impossible to transmit signal electric charges to the next step from “the two mode operation electrode set” to which “the non-transmission clocks” are given.

When “the two mode operation electrode set” operated as described above is appropriately arranged in the second vertical CCD 4 and it is properly selected whether the clocks given to the transmission electrode are made to be “the transmission clocks” or “the non-transmission clocks”, packets of the signal electric charges, which are sent from the first vertical CCD 3 in parallel with each other, can be arranged in time series.

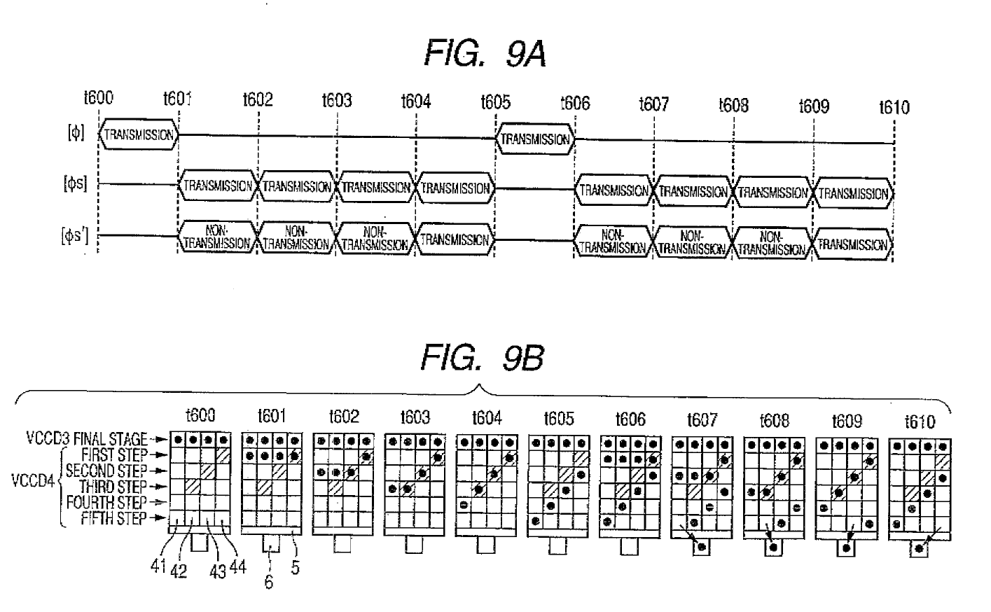

FIGS. 9A and 9B are schematic illustrations showing a rearrangement of the signal electric charges executed by the second vertical CCD 4. In the timing chart of FIG. 9A, [100 ] is a clock given to the first vertical CCD 3, [φₛ] is a clock given to “the one mode operation electrode set” of the second vertical CCD 4, and [φₛ′] is a clock given to “the two mode operation electrode set” of the second vertical CCD 4.

“Transmission” expresses that “the transmission clocks” are given to the corresponding electrode. “Non-transmission” expresses that “the non-transmission clocks” are given to the corresponding electrode. Blank expresses that the clock operation is not executed for the corresponding electrode.

In the schematic illustration showing a rearrangement and transmission of FIG. 9B, one electrode set of the second vertical CCD 4 is used as one unit. FIG. 9B shows the final step of the first vertical CCD 3, all steps of the second vertical CCD 4, the OG 5 and the FD section 6.

In the drawing, the black circle mark corresponds to a signal electric charge. When the signal electric charge is transmitted, the black circle mark is moved to the lower step. FIG. 9B shows circumstances in which the signal electric charge is sent to the FD 6. In this connection, the second vertical CCD 4, the number of which is 4, are respectively attached with the marks “41”, “42”, “43” and “44” in this order from the left.

In the second vertical CCD 41 at the left ends “the two mode operation electrode set” is not arranged. In the third step of the second vertical CAD 42 adjacent to the second vertical CAD 41 on the right, “the two mode operation electrode set” is arranged. In the second step of the next second vertical CCD 43, “the two mode operation electrode set” is arranged. In the first step of the second vertical CCD 44 at the right end, “the two mode operation electrode set” is arranged. The portion of “the two mode operation electrode set” is shown being hatched in FIG. 98.

Time t600 represents an initial state, In the final step of the first vertical CCD 3, signal electric charges are accumulated. After that, when the transmission clock is given to [φ] as shown in FIG. 9A, the signal electric charges accumulated in the final step of the first vertical CCD 3 are transmitted to the first step of the second vertical CCD 4 at the time t601. To the final step of the first vertical CCD 3, the signal electric charges existing in the front step are transmitted. At the time t606, the transmission clocks are next given to [φ]. Therefore, the signal electric charges of the final step of the first vertical CCD 3 are maintained till the time t605 as they are.

At the time t602, the transmission clocks are given to [φₛ] and the non-transmission clocks are given to [φₛ′]. Then, the electric charges in the first step of the second vertical CCD 41 to 43 are transmitted and the electric charge in the first step of the second vertical CCD 44 is not transmitted. Accordingly, at the time t602, the electric charges of the second vertical CCD 41 to 43 advance to the second step and the electric charge of the second vertical CCD 44 in left in the first step

Successively, the transmission clock is given to [φₛ] and the non-transmission clock is given to [φₛ′]. Then, the electric charges of the second vertical CCD 41, 42 are transmitted and the electric charges of the second vertical CCD 43, 44 are not transmitted and remain at the same places. Therefore, at the time t603, the electric charges of the second vertical CCD 41, 42 remain in the third step, the electric charge of the second vertical CCD 43 remains in the second step and the electric charge of the second vertical CCD 44 remains in the first step.

When controlling is executed in the same manner, at the time t604, the electric charge of the second vertical CCD 41 is distributed in the fourth step, the electric charge of the second vertical CCD 42 is distributed in the third step, the electric charge of the second vertical CCD 43 is distributed in the second step, and the electric charge of the second vertical CCD 44 is distributed in the first step, that is, all the electric charges are distributed in the different places.

That is, the signal electric charge, which are arranged in the first step in parallel with each other at the time t601, are rearranged in order at the time t604.

Next, when the transmission clocks are given together with [φₛ] and [φₛ′], four signal electric charges are transmitted to the next step. Next, when the transmission clocks are given to [φ], the signal electric charge in the final step of the first vertical CCD 3 is transmitted to the Second vertical CCD 4 again. Operation of the tour signal electric charges, which are newly transmitted to the second vertical CCD 4, is the same as that explained at the time t600 to t604.

When the transmission advances in the state of the time t605 and t606, that is, when the transmission advances in the state in which positions in the vertical direction of the four signal electric charges are different from each other, at the time t607, the signal electric charge existing in the second vertical CCD 41 is sent to the FD section 6 through the OG 5 and converted to a voltage value signal corresponding to an amount of the signal electric charge.

At the next time t608, the signal electric charge existing in the second vertical CCD 42 is converted to a voltage value signal. At the time t609, the signal electric charge existing in the second vertical CCD 43 is converted to a voltage value signal. At the time t610 the signal electric charge existing in the second vertical CCD 44 is sent to the FD section 6 and converted to a voltage value signal. As described above, as a result, the voltage value signals corresponding to the electric charges of four signal electric charges are read out in time series in the order of the second vertical CCD 41→42→43→44.

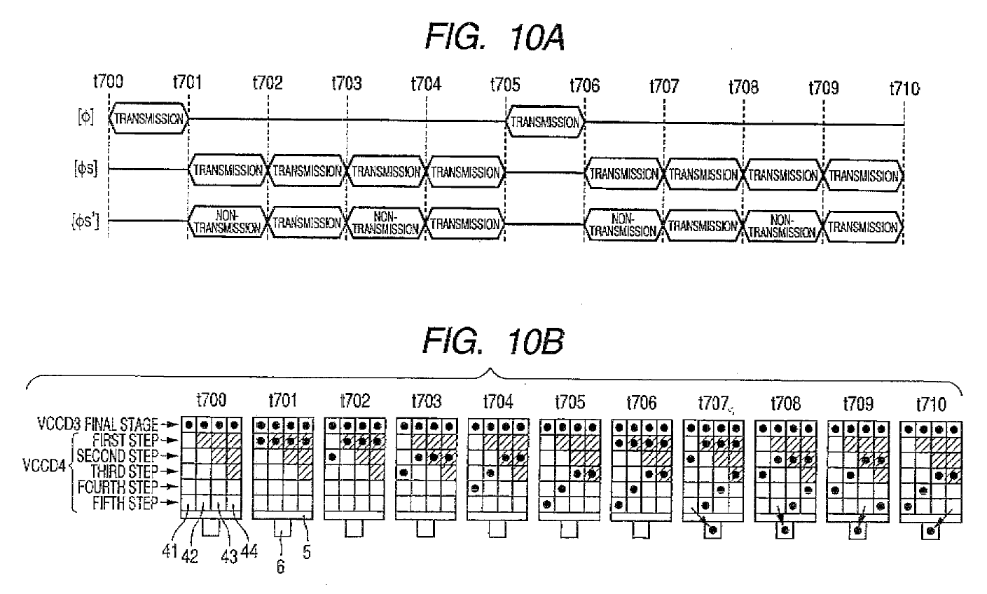

FIGS. 10A and 10B are schematic illustrations for explaining an execution of outputting in time series of another embodiment of the present invention. In the present embodiment, a position, at which “the two mode operation electrode set” is arranged, is different from that of FIGS. 9A and 9B. In the example shown in FIGS. 10A and 10B, “the two mode operation electrode set” does not exist in the second vertical CCD 41. In the second vertical CCD 42, “the two mode operation electrode set” is arranged in the first step. In the second vertical CCD 43, “the two mode operation electrode set” is arranged in the first step and the second step. In the second vertical CCD 44, “the two mode operation electrode set” is arranged in the first to the third step. In the present embodiment, in the same manner as that of the embodiment shown in FIGS. 9A and 9B, the electrode structure (the arrangement position of the two mode operation electrode set) of the individual second vertical CCD 4 in the same group is different. Therefore, the individual second vertical CCD 4 is individually controlled.

At the time t700, it is in the initial state. Signal electric charges are accumulated in the final step of the first vertical CCD 3. When [φ] is given transmission clocks, the signal electric charges accumulated in the final stop of the first vertical CCD 3 are transmitted to the first step of the second vertical CCD 4 and a state of the time t701 is made.

Next, when the transmission clocks are given to [φₛ] and the non-transmission clocks are given to [φₛ′], only the electric charge in the first step of the second vertical CCD 41 is transmitted and the electric charges existing in the first steps of the second vertical CCD 42 to 44 are not transmitted. Therefore, a state of the time t702 can he obtained.

Next, when the transmission clocks are given to both [φₛ] and [φₛ′], the transmission is executed to all the second vertical CCD 41 to 44. Therefore, in the second vertical CCD 41, the transmitting position of the signal electric charge advances from the second step to the third step. In the second vertical CCD 42 to 44, the transmitting position to the signal electric charge advances from the first step to the second step (the time t703).

When the above operation is repeated, a rearrangement is gradually made in the second vertical CCD 41 to 44 according to the predetermined order. In the same manner as that shown in FIGS. 9A and 9B, it is possible to read out the voltage value signals of the signal electric charges in time series in the order of the second vertical CCD 41→42→43→44.

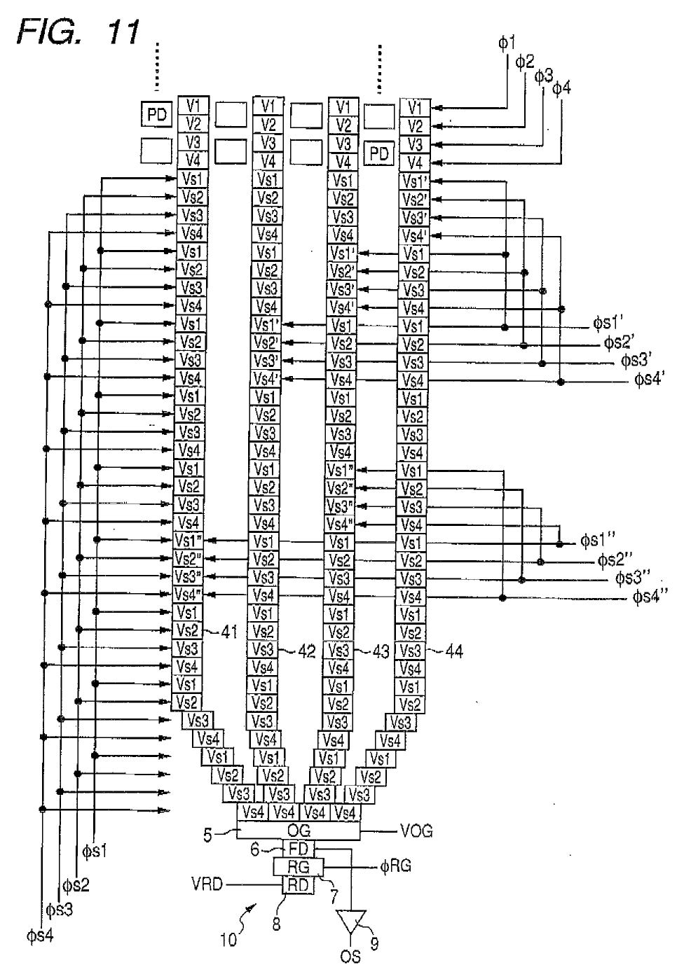

FIG. 11 is an arrangement view showing an example of the embodiment of the present invention in which the signal electric charges transmitted by the vertical CCD are added, that is, a so-called pixel mixing is executed. In the embodiment shown in FIGS. 2A, 2B, 9A, 9B, 10A and 10B, the signal electric charges are rearranged simply in time series. However, in the present embodiment, the signal processing, which is referred to as a pixel mixing, is executed in the rearrangement vertical transmitting register region B.

In the solid state imaging element, the constitution of the primary portion of which is shown in FIG. 11, two types of [the two mode operation electrode sets] are prepared. One is [the electrodes Vₛ1′ to Vₛ4′] and the other is [the electrodes Vₛ1″ to Vₛ4″]. These are arranged in one portion of the second vertical CCD 4 and respectively impressed with the clocks [φₛ′] and [φₛ″].

Concerning the arrangement of the electrode set, the first “two mode operation electrode sets” composed of the electrodes Vₛ1′ to Vₛ4′ are respectively arranged in the third step of the second vertical CCD 42, the second step of the second vertical CCD 43 and the first step of the second vertical CCD 44. The second “two mode operation electrode sets” composed of the electrodes Vₛ1″ to Vₛ4″ are respectively arranged in the sixth step of the second vertical CCD 41 and the fifth step of the second vertical CCD 43.

By using the rearrangement vertical transmission register region B, the constitution of which is described above, the following items will be explained.

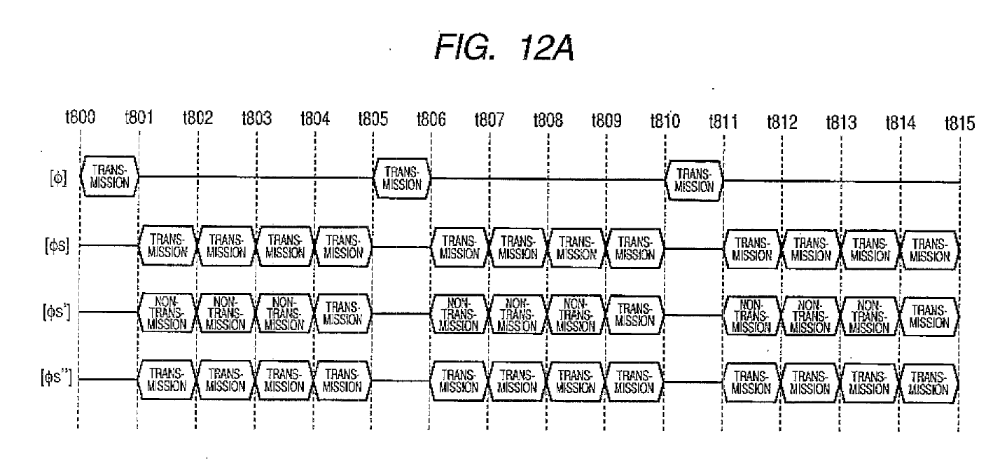

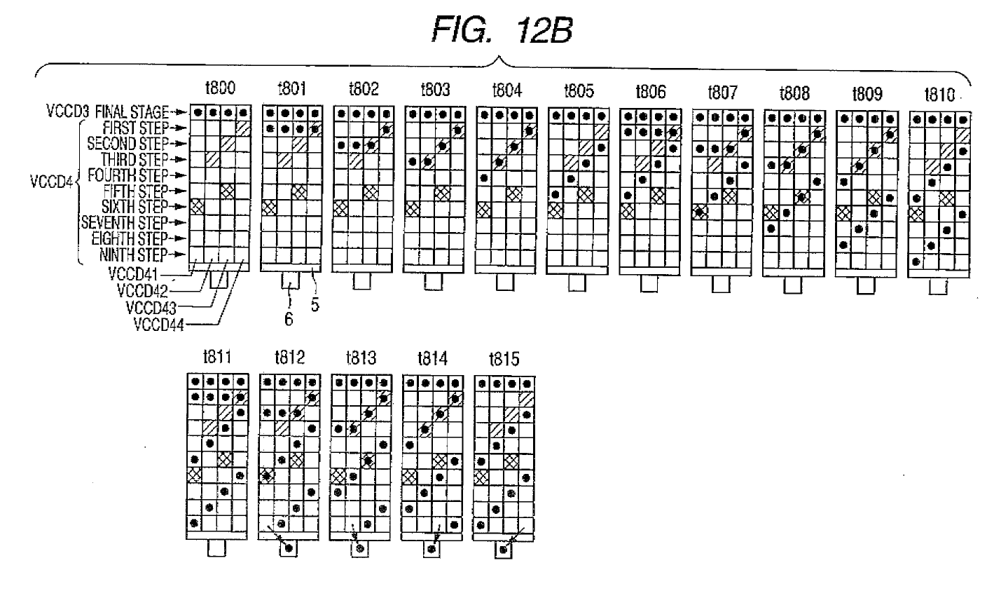

(1) Operation of executing the usual time series output without mixing pixels (FIGS. 12A and 12B)

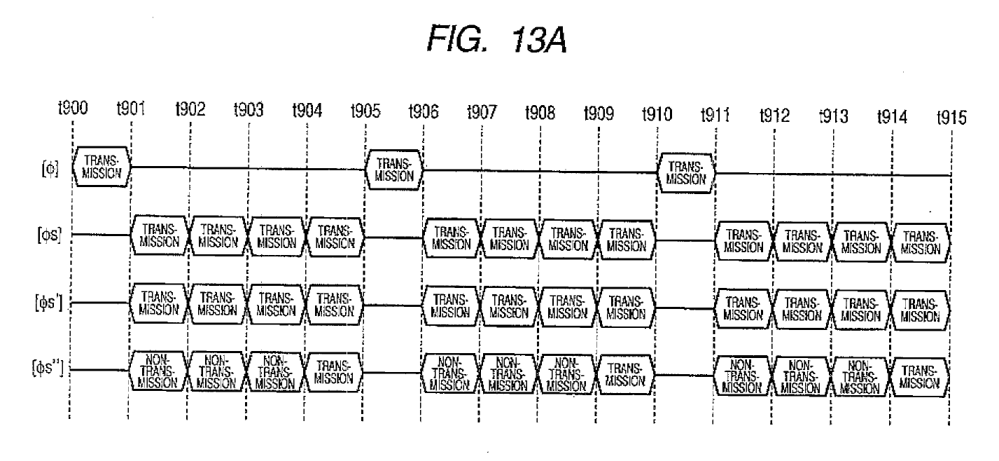

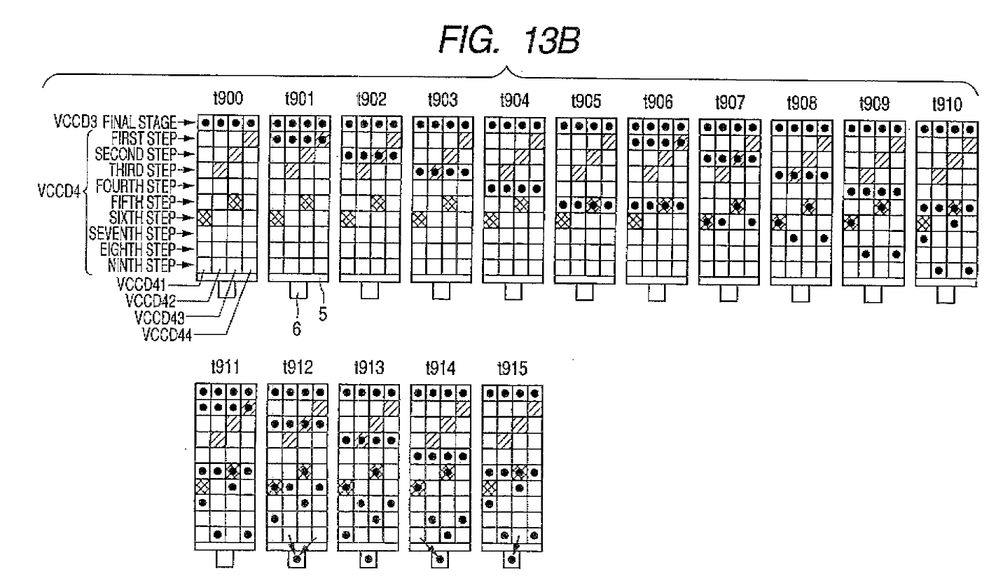

(2) Operation of executing the output by mixing pixels (FIGS. 13A and 13B)

In FIG. 12B, the time t800 shows the initial state and signal electric charges are accumulated in the final step of the first vertical CCD 3. After that, when the transmission clocks are given to [φ] as shown in FIG. 12A, the signal electric charges accumulated in the final step of the first vertical CCD 3 are transmitted at the time t801 to the first step of the second vertical CCD 4. At this timer the next electric charges are transmitted tram the front step to the final step of the first vertical CCD 3.

During the period until the successive time t801 to t805, the same operation as that explained in FIGS. 9A and 9B is executed and the signal electric charges are rearranged so that outputting can be executed in time series.

The second electrode set Vₛ″ to Vₛ4″, which is shown being cross-hatched in FIG. 12B, is given usual transmission clocks. Therefore, the rearranged electric charge packet is simply transmitted while the positional relation is being maintained as it is. Finally, signal electric charges are transmitted to the FD section 6 from the second vertical CCD 41, 42, 43, 44 in order. In this way, outputting is executed in time series.

In this case, the rearrangement of outputting in time series is executed by using the region (the first to the fourth step) in which the first “two mode operation electrode set” is arranged. The usual transmission is executed by giving the transmission clocks to the region (the fifth to the eighth step) in which the second “two mode operation electrode set” is arranged. In this way, two operations are combined with each other, outputting in time series can be realized.

Next, referring to FIGS. 13A and 13B, operation in the case of executing the pixel mixing will be explained below. The time t900 represents the initial state and signal electric charges are accumulated in the final step of the first vertical CCD 3. After that, when the transmission clocks [φ] are given to the first vertical CCD 3, the signal electric charges accumulated in the final step of the first CCD 3 at the time t901 are transmitted to the first step of the second vertical CUD 4 and the next electric charges are transmitted from the front step to the final step of the first vertical CCD 3.

For example, four signal electric charges transmitted to the second vertical CCD 41, 42, 43, 44 are a signal electric charge of the red (R) pixel, a signal electric charge of the green (G) pixel, a signal electric charge of the blue (B) pixel and a signal electric charge of the green (G) pixel in this order. Signal electric charges of two green (G) pixels are added and outputted.

With respect to the first “two mode operation electrode set” of the first to the fourth step of the second vertical CCD 4, the transmission clocks are given as [φₛ″]. Therefore, at the time t901 to t905, all signal electric charges are simultaneously transmitted and advanced to the fifth step.

During the period of the time t906 to t909, the non-transmission clocks are given to [φₛ″]. Therefore, as shown in the drawing, when the signal electric charge of the second vertical CCD 41 of the left end reaches the sixth step, the electric charge is not transmitted anymore. When the signal electric charge of the second vertical CCD 43 reaches the fifth step, the electric charge is not transmitted anymore. Therefore, the electric charges are respectively held in the sixth step and the fifth step and the signal electric charges of the second vertical CCD 42 and 44 are held in the same eighth step.

After that, only “one mode operation electrode set” exists. Accordingly all of them are simultaneously transmitted and the transmission proceeds while the same positional relation is being maintained. At the time t912, the signal electric charges of the second vertical CCD 42 and 44 are simultaneously sent to the FD section 6 and voltage value signals corresponding to the two signal electric charges are outputted. That is, it is possible to obtain an output equivalent to the state in which a pixel signal for generating the signal electric charge of the second vertical CCD 42 and a pixel signal for generating the signal electric charge of the second vertical CCD 44 are added to each other, that is, the two pixels are mixed with each other.

At the time t914, the signal electric charge of the second vertical CCD 41 is singly sent to the FD section C. At the next time t915, the signal electric charge of the second vertical CCD 43 is singly sent to the FD section 6.

The above explanations are summarized as follows. In the region in which the first “two mode operation electrode set” of the first to the fourth step is arranged, the transmission clock is given and the signal electric charge is thoroughly transmitted. In the region in which the second “two mode operation electrode set” of the fifth to the eighth step is arranged, the non-transmission clock is given and the signal electric charges are rearranged corresponding to the pixel mixing. When the two operations described above are combined with each other, a pixel mixing output can be realized.

As explained above, according to the present embodiment, the signal electric charge of the second vertical CCD 42 and the signal electric charge of the second vertical CCD 44 are outputted while the pixel mixing is being executed, and the signal electric charge of the second vertical CCD 41 and the signal electric charge of the second vertical CCD 43 are outputted while the pixel mixing is not being executed The above complicated operation can be executed only by the arranging position of “two mode operation electrode set” and the clock operation.

In this connection, in the present embodiment, an example is explained in which when four vertical CCD 41 to 44 are gathered to each other and outputting is executed from one FDA 10, and a rearrangement is made in time series or corresponding to the pixel mixing. However, of course, the number of the vertical CCD is not limited to “four” in the present invention. It is possible to gather an arbitrary number of the vertical CCD.

The number of the transmission steps of the second vertical CCD 4 gathered into one group is the same. In the example shown in FIGS. 9A, 9B, 10A and 10B, the number of the transmission steps is five. In the example shown in FIGS. 12A, 12B, 13A and 13B, the number of the transmission steps is nine. However, the number of the transmission steps is not necessarily limited to the above specific numbers. In the case where one group has the vertical CCD, the number of which is n, when the number of the transmission steps is at least (n-1), it is possible to output signal electric charges in time series, the number of which is n.

The arranging method of “two mode operation electrode set” is not limited to the specific arranging position described in the above embodiment. It is possible to employ various combinations Further, the pixel mixing explained in the above embodiment is not limited to the output addition of two vertical CCD out of four vertical COD. The arranging method and the driving method of “two mode operation electrode set” can be variously changed.

As described in the above embodiment, without using horizontal electric charge transmission passages, outputting in time series can be executed in the block including a plurality of vertical CCD. When this structure is employed, an addition of the signal electric charges for each vertical CCD can be realized without executing a complicated control and processing. Further, when a plurality of vertical CCD are gathered, the number of the vertical CCD is seldom restricted. Accordingly, the embodiment can be easily realized.

The arranging order of the signal electric charges to be transmitted is made when the electrodes capable of controlling “whether the electric charge is transmitted or the electric charge is not transmitted” axe provided except for the transmission electrodes to execute the usual transmission. Therefore, it is unnecessary to add a new circuit. In the manufacturing process of the solid state imaging element, it unnecessary to provide an additional process. Since the horizontal CCD is not needed, the manufacturing process of the solid state imaging element can be reduced. Therefore, the manufacturing cost of the chip can be reduced.

In this connection, in the embodiment described above, explanations are made into an example in which the pnoto-diodes are arranged in the lattice in the region A as shown in FIG. 1. However, of course, the above embodiment can be applied as it is to a solid state imaging element, the pixel arrangement of which is a so-called honeycomb arrangement, in which the even-numbered photo-diode lines are shifted by ½ pitch with respect to the odd-numbered photo-diode lines so that the vertical CCD 3 arranged between the photo-diode lines can be arranged in a snaking shape as described in the official gazette of JP-A-10-136391.

According to the present invention, the horizontal electric charge transmission means is eliminated and a plurality of second electric charge transmission means of the same transmission steps are connected to the first electric charge transmission means. Therefore, the layout can be easily designed and the manufacture can be easily made. Further, when an order of the transmission in the second electric charge transmission means is controlled, it becomes possible to output signals in the group in time series and it becomes unnecessary to provide a horizontal transmission register driven at a high speed. Accordingly, the number of pixels of the solid state imaging element can be easily increased and reading can be easily executed at a high speed.

The solid state imaging element of the present invention and the driving method thereof can he easily realized. Therefore, the present invention can be effectively applied to a solid state imaging element in which the number of pixels is increased and a high speed burst shot is made.

The entire disclosure of each and every foreign patent application from which the benefit of foreign priority has been claimed in the present application is incorporated herein by reference, as if fully set forth.

What is claimed is:

1. A solid state imaging element comprising:
a plurality of photoelectric conversion elements arranged in a two-dimensional array-shape;
a plurality of first electric charge transmission sections that transmit signal electric charges detected by the photoelectric conversion elements;
a plurality of second electric charge transmission sections having the same transmission stage numbers, wherein said plurality of second electric charge transmission sections corresponds to said plurality of first electric charge transmission sections respectively and comprises plural subgroups each including adjacent second electric charge transmission sections in given numbers;
electric charge detection sections that detects the signal electric charge transmitted from said plurality of second electric charge transmission sections, each of the electric charge detection sections being provided for each of the plural subgroups; and
a transmission control section that controls, for each of the plural subgroups, an order of transmission of the signal electric charges detected by the electric charge detection sections.

2. A solid state imaginq element according to claim 1,
wherein the transmission control section controls the order of transmission by controlling independently each of the second electric charge transmission sections in each of the plural subgroups .

3. A solid state imaging element according to claim 1,
wherein the transmission control section controls, for each of the plural subgroups, the order of transmission by controlling transmission/non-transmission to a next step of a signal electric charge which has been transmitted to a given position in the second electric charge transmission sections.

4. A solid state imaginq element according to claim 1,
wherein the transmission control section transmits, for each of the plural subgroups, all or a portion of the signal electric charges in time series to corresponding one of the electric charge detecting sections.

5. A solid state imaging element according to claim 1,
wherein the transmission control means transmits, for each of the plural subgroups, the signal electric charges which have been transmitted in a plurality of predetermined second electric charge transmission sections to corresponding one of the electric charge detection sections at the same time.

6. A driving method of driving a solid state imaging element,
the solid state imaging element comprising:
a plurality of photoelectric conversion elements arranged in a two-dimensional array-shape;
a plurality of first electric charge transmission sections that transmits signal electric charges detected by the photoelectric conversion elements;
a plurality of second electric charge transmission sections having the same transmission stage numbers, wherein said plurality of second electric charge transmission sections corresponds to said plurality of first electric charge transmission sections respectively and comprises plural subgroups of the adjacent second electric charge transmission sections in given numbers; and
electric charge detection sections that detects the signal electric charge transmitted from said plurality of second electric charge transmission sections, each of the electric charge detection sections being provided for each of the plural subgroups of the second electric charge transmission sections,
wherein the driving method comprising:
controlling each of the plural subgroups of the second electric charge transmission sections so as to control an order of transmission of a given number of signal electric charges in each of the plural subgroups to corresponding one of the electric charge detecting sections.
